(19) United States
(12) Patent Application Publication
(10) Pub. No.: US 2024/0265321 A1
(43) Pub. Date: Aug. 8, 2024

(54) BREAK AND TASK MANAGEMENT

(71) Applicant: Marc Neubauer, Silver Spring, MD (US)

(72) Inventor: Marc Neubauer, Silver Spring, MD (US)

(21) Appl. No.: 18/639,861

(22) Filed: Apr. 18, 2024

Related U.S. Application Data
(63) Continuation-in-part of application No. 17/745,041, filed on May 16, 2022.
Application No. 17/745,041 is a continuation-in-part of application No. 17/506,673, filed on Oct. 21, 2021, now Pat. No. 11,380,186.
(60) Provisional application No. 63/460,126, filed on Apr. 18, 2023.
(60) Provisional application No. 63/539,977, filed on Sep. 22, 2023.
(60) Provisional application No. 63/246,241, filed on Sep. 20, 2021.
(60) Provisional application No. 63/236,788, filed on Aug. 25, 2021.
(60) Provisional application No. 63/214,409, filed on Jun. 24, 2021.

(51) Int. Cl. G06Q 10/0631

(52) U.S. Cl. CPC G06Q 10/063116

(57) ABSTRACT

Methods and apparatus for managing a break are disclosed. The method comprises steps of determining that a first staff member needs a break having a start time and a duration, automatically identifying a task that is assigned to the first staff member and conflicts with the break, and notifying the first staff member, if no conflicting task is identified, to take the break at the start time.

### CROSS-REFERENCE TO RELATED APPLICATIONS

This application is a Continuation-In-Part of U.S. non-provisional application Ser. No. 17/745,041 filed May 16, 2022 that claims priority to U.S. non-provisional application Ser. No. 17/506,673 filed Sep. 20, 2021 now issued as U.S. Pat. No. 11,308,186 that claims priority to U.S. provisional applications 63/246,241 filed Sep. 20, 2021 and 63/236,788 filed Aug. 25, 2021 and 63/214,409 filed Jun. 24, 2021, and further claims priority to U.S. provisional applications 63/460,126 filed Apr. 18, 2023 and 63/539,977 filed Sep. 22, 2023, all of which are incorporated herein in their entireties by reference.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### BACKGROUND

### Field

The present invention generally relates to assignment and scheduling of tasks and breaks to staff members and, in particular, re-assignment of tasks between staff members, modification of dynamic attributes, and reporting of tasks in break coverage reports to ensure that staff members are able to take breaks so as to reduce fatigue.

### Description of the Related Art

Conventional systems and methods of managing staff member schedules that include breaks are largely manual or, at best, based on broad assignment of responsibility, for example assignment of a patient to a nurse. It is left to the individual staff member to determine when to perform tasks or whether a break may be taken at a particular time without adverse impact to patient care. In a hospital, nurses often skip one or more of their daily breaks out of concern that their patients will not receive adequate care during the break or that an important care task will not be completed within the associated time window. These static systems that do not consider changeable factors lead to missed breaks and interruption of breaks especially in hospital units where clinicians and support staff have a high patient-staff assignment load, e.g. 10:1.

### SUMMARY

What is needed is an automatic system that collects information about assigned tasks and breaks to be taken by staff members and provides guidance on when a break may be taken with the assurance that all tasks can be properly completed. This system needs to consider the dynamic attributes of staff members, tasks, shifts, patients and breaks to be able to modify break schedules, modify dynamic attributes and reassign tasks to execute on break schedules, and report these changes to staff members to ensure a safe and equitable workload where clinician health and job satisfaction are emphasized. The systems and methods described herein fulfill this need.

### BRIEF DESCRIPTION OF THE DRAWINGS

Aspects of the disclosure are herein described, by way of example only, with reference to the accompanying drawings. With specific reference now to the drawings in detail, it is stressed that the particulars shown are by way of example and are for purposes of illustrative discussion of aspects of the disclosure. The description and the drawings, considered alone and together, make apparent to those skilled in the art how aspects of the disclosure may be practiced.

FIG. 1 depicts an exemplary workflow for managing a break for an individual, according to certain aspects of the present disclosure.

FIG. 2 depicts an exemplary workflow for managing options for giving a staff member a break, according to certain aspects of the present disclosure.

FIG. 3 depicts an exemplary workflow for enabling a staff member to control their own break schedule, according to certain aspects of the present disclosure.

FIG. 4 depicts an exemplary workflow for managing a break schedule for staff members in a care unit, according to certain aspects of the present disclosure.

FIG. 5 depicts an exemplary workflow for assigning a task in response to an initiating event, according to certain aspects of the present disclosure.

FIG. 6 depicts an exemplary workflow for reducing fatigue in a staff member, according to certain aspects of the present disclosure.

FIG. 7 depicts an exemplary workflow for re-assigning a task from one staff member to another staff member, according to certain aspects of the present disclosure.

FIG. 8 depicts an exemplary workflow for handing off tasks from one staff member to another staff member, according to certain aspects of the present disclosure.

FIG. 9 depicts an exemplary system for managing tasks and breaks, according to certain aspects of the present disclosure.

### DETAILED DESCRIPTION

This description is intended to illustrate some particular embodiments of the disclosure and not to exhaustively specify all permutations, combinations and variations thereof. Features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure and do not depart from the instant disclosure. In some instances, well-known structures, interfaces, and processes have not been shown in detail in order not to unnecessarily obscure the invention. It is intended that no part of this specification be construed to effect a disavowal of any part of the full scope of the invention.

Unless otherwise defined herein, all technical and scientific terms used herein have the same meaning as commonly understood by one of ordinary skill in the art to which this disclosure belongs. The terminology used in the description of the disclosure herein is for the purpose of describing particular aspects or embodiments only and is not intended to be limiting of the disclosure. References to techniques employed herein are intended to refer to the techniques as commonly understood in the art, including variations on those techniques or substitutions of equivalent techniques that would be apparent to one of skill in the art.

Unless the context indicates otherwise, it is specifically intended that the various features of the disclosure described herein can be used in any combination. Moreover, the present disclosure also contemplates that in some embodiments of the disclosure, any feature or combination of features set forth herein can be excluded or omitted.

The methods disclosed herein comprise one or more steps or actions for achieving the described method. The method steps and/or actions may be interchanged with one another without departing from the scope of the present disclosure. In other words, unless a specific order of steps or actions is required for proper operation of the embodiment, the order and/or use of specific steps may be modified without departing from the scope of the present disclosure.

### Task and Break Management

While the disclosure and examples provided herein are directed to a healthcare environment, e.g., a hospital with care units staffed by nurses and other staff members such as physicians, pharmacists, certified nursing assistants, break nurses, respiratory therapists, radiologic technicians, biomedical engineers, the systems and methods are equally applicable to other environments where the assigned workload and work tasks are subject to change and must be apportioned among a group of staff members. These traits are particularly common in environments that are fast-paced, have variable demand or require teamwork to manage workflows efficiently. For example, the disclosure and examples provided herein can be applied to a retail pharmacy where pharmacists work long hours with limited breaks, where tasks are subject to change. Other applicable fields include retail and wholesale shipping and distribution centers, IT and customer call centers, and software development teams working in fast paced, AGILE environments.

Nurses often skip breaks out of a concern that there may be a gap in the care provided to their assigned patients. While another nurse may be assigned to “cover” for the nurse while on break, the cover nurse has their own set of patients and tasks to accomplish and may not be able to perform important tasks or respond to unscheduled events such as a medical device alarm. This is particularly a problem with the medical-surgical units of a hospital, where nurses often have demanding patient-staff ratios, e.g., 8:1 or even 10:1, and do not have dedicated breaks nurses to cover their breaks. This situation is exacerbated if the unit is short-staffed but there may be little, if any, tangible data to document an overload of the staff. As a result of not taking all their allocated breaks, nurses will experience an increased level of fatigue that may lead to a reduction in the quality of care that they provide, a reduction in their wellbeing, or a reduction in their job satisfaction and job retention status.

The systems and methods disclosed address problems of conventional methods by introducing an automatic system that collects information about the assigned tasks, for example the time windows in which each task should be completed and the time that it takes to perform each task, as well as a compilation of the breaks that should be taken on a shift, for example the number and duration of the breaks. Using rules and constraints that are based on one or more of regulations, hospital policies, staff member break preferences, and best practices, the system compares candidate schedules to identify a schedule for a nurse for their shift in which tasks can be reassigned between different staff members and be accomplished without delay of care and every break can be taken at a defined start time for a defined duration. If it is not possible to execute on a scheduled break on first analysis, the system can modify the dynamic attributes disclosed herein, e.g. break dynamic attributes, and/or reassign tasks based on dynamic attributes to provide the staff member with a break. If the modification of dynamic attributes or reassignment of tasks does not address the situation, then the system identifies the conflicts and provides documentation of the task overload or other factors that prevent the nurse from having enough time to complete the assigned tasks while also taking enough break time.

### Dynamic Attributes

As used within this disclosure, the phrase “dynamic attribute” refers to all changeable factors associated with a patient, a staff member, a task, a shift or a break. Dynamic attributes consider the changeable factors for an individual entity, e.g., a shift, a staff member; and between different entities, e.g., between one shift and another, between staff member A and staff member B.

Break dynamic attributes are attributes that can change on a break or between two different breaks. They may influence how breaks are scheduled and how break schedules are executed to ensure staff members receive their breaks. Break dynamic attributes include, but are not limited to, a start time, a duration, a break type, e.g., a meal break or a training session, a break priority, a second staff member to share the break with, a location of the break, an item to bring to break, e.g., training material, number of breaks per clinician per shift, a break preference of a staff member, e.g. staff member A prefers early meal breaks, and what type of tasks to reduce and what type of tasks to still assign during a period defined as a break.

Shift dynamic attributes are defined as attributes that can change on a shift or between one shift and another. Shift dynamic attributes may influence how breaks are scheduled and/or executed on a shift or how tasks are reassigned on shift. Shift dynamic attributes include, but are not limited to, staffing, shift hours, type of shift (e.g., day shift or night shift), ADT information, type and severity of medical conditions treated during shift, patient/staff assignments ratios, acuity of patients on a given shift, stability of patients on a given shift, number of overtime (OT) hours scheduled and/or worked by staff on a unit during a shift, availability of support staff (e.g., certified nursing assistants and/or break nurses), number of breaks to be scheduled, breaks hour to be scheduled, number of breaks missed or interrupted on a prior shift, community events near hospital during shift, and weather and traffic events during shift. In certain embodiments, shift dynamic attributes include outstanding tasks that need to be carried over from the previous shift to the shift being planned.

Task dynamic attributes are defined as attributes that can change with a task or between two different tasks. Task dynamic attributes may influence how tasks are assigned or reassigned to different staff members and how tasks are communicated to staff on task lists or reports, e.g., break transfer summary reports. Task dynamic attributes include but are not limited to, task priority, tasks completed, time of completion, staff member assigned task, staff member who completed task, outstanding tasks, origination and received times of outstanding tasks, priority of outstanding tasks, and notes or instructions associated with tasks, e.g. instruction to double verify certain medical administration tasks.

Patient dynamic attributes are defined as attributes that can change with a patient or between two or more patients. Patient dynamic attributes may influence a task priority and how tasks are assigned, reassigned, or escalated to different staff members. Patient dynamic attributes include, but are not limited to, the examples listed in Table 1.

TABLE 1

| | |
|---|---|
| FACTOR | EXAMPLE |

Patient Monitor Factors (currently being measured or periodically assessed)

| | | | |
|---|---|---|---|
| 1 | | patient health | |
| | a. | a patient health measurement | vital signs, labs, point of care |
| | | | parameter, diagnostic test result |
| | b. | change in the score of a patient | Modified Early Warning Score |
| | | health assessment | (MEWS), Acute Physiology and |
| | | | Chronic Health Evaluation |
| | | | (APACHE) 2 |
| 2 | | an action by the patient | |
| | a. | detection of motion | patient motion detected directly at |
| | | | same time as alarm known to be |
| | | | induced by motion |
| | b. | loss of signal; abnormal signal | patient motion disconnects an EKG |
| | | | lead causing alarm for low pulse rate |

Identification, Treatment, and Diagnostic Factors (from a hospital system)

| | | | |
|---|---|---|---|
| 3 | | a doctor's order | administer a medication (dose, |
| | | | method, frequency, etc.), specific |
| | | | settings of a medical device |
| 4 | | a patient instruction | a Do Not Resuscitate (DNR) order |
| 5 | | patient medical record | |
| | a. | a patient identifier | Age, gender, ethnicity, blood type, |
| | | | height, weight |
| | b. | a diagnosis of an underlying | heart disease, congenital heart defect, |
| | | condition of the patient | diabetes |
| | c. | an inherent characteristic of the | a genetic marker, an inherited |
| | | patient | condition, e.g., patient is a carrier of |
| | | | hemophilia |
| | d. | whether patient has received a | an implanted device |
| | | treatment that affects a condition | |
| | e. | whether a patient has previously | note in electronic medical record |
| | | experienced a symptom for a | (EMR) of fainting, dizziness, nausea |
| | | condition | |
| | f. | changes in a patient's condition | worsens or improves after an |
| | | | intervention |

Medication Factor (from medication library in a hospital system or standalone medication
library)

| | | | |
|---|---|---|---|
| 6 | | an indication for use of | Vasopressors are indicated to raise |
| | | a medication or fluid being | blood pressure (BP) |
| | | administered to the patient; | |
| 7 | | characteristics of medication or | |
| | | fluid | |
| | a. | intended effect | blood thinning medications indicated |
| | | | for patients with atrial fibrillation to |
| | | | reduce chance of stroke |
| | b. | side effect | thyroid medication can cause very |
| | | | fast heart rate and irregular heart |
| | | | rhythm |
| | c. | patient health measurement | vasopressors increase blood pressure, |
| | | affected by a medication | insulin lowers blood sugar |
| | d. | pharmacokinetic or | PK - e.g., biological half-life |
| | | pharmacodynamic (PK/PD) | PD - e.g., drug-drug interactions |
| | | characteristic | |

Medical Device Factors (configuration or operational performance)

| | | |
|---|---|---|
| 8 | a setting of the medical device | delivery rate of an IV fluid; oxygen |
| | | content of delivered air |
| 9 | an operating mode of the medical | running on battery power, ventilator |
| | device | set to allow spontaneous breathing |
| 10 | an operational status of the | infusion pump has stopped infusing a |
| | medical device | fluid; a ventilator has stopped |
| 11 | a measured aspect of operation of | Measured battery voltage (indication |
| | the medical device | of remaining operational time), tidal |
| | | volume of each breath |
| 12 | whether there is a secondary | tidal volume sensing as secondary |
| | mechanism to mitigate harm | indication of respiration if airway |
| | associated with alarm | pressure alarm occurs, back-up |
| | | battery |
| 13 | A feature of a device | Electrocardiogram (ECG) filter mode, |
| | | number of leads used for monitoring |
| 14 | number of previous | high number indicates artifact, |
| | nonactionable or false alarms | reliability issues, or environmental |
| | received before alarm received | issues, e.g., electromagnetic |
| | | interference |
| 15 | estimated time to perform a | replace a non-operational ventilator or |
| | corrective action | pump |
| 16 | recommended replacement | ECG leads should be changed 1x or |
| | interval of a consumable | 2x per day to reduce false alarms |

As used within this disclosure, the phrase “patient health measurement” refers to one or more of the following patient characteristics: a vital sign, a point-of-care (POC) observation or symptom, a diagnostic test, or a laboratory test. These measurements include but are not limited to body temperature, heart rate, blood pressure, respiration rate, tidal volume, blood oxygenation, blood glucose level, an arrhythmia, and end-tidal carbon dioxide (ETCO2).

As used within this disclosure, the phrase “laboratory test” refers to analysis of a biological sample from the patient, e.g., blood. The analysis may be performed at the bedside or at a remote location.

As used within this disclosure, the phrase “patient health assessment” is an algorithm that may be used to categorize a patient's health or cognitive status, to triage a patient, or to monitor a patient to determine if their condition is improving or worsening. A patient health assessment may be a nationally or locally recognized set of criteria or algorithm or one defined and implemented by a hospital or network of hospitals. For example, a patient's acuity status may be evaluated using the Oulu Patient Classification System. The complexity of a patient's condition may be evaluated using the Charlson Comorbidity Index (CCI) or the Patient Clinical Complexity Level (PCCL) algorithms. Other examples of patient health assessments include a patient pain algorithm, a patient disease severity algorithm, a patient awareness algorithm, a patient agitation algorithm, a patient deterioration algorithm, and a mortality score such as the APACHE 2.

Staff dynamic attributes are defined as attributes that can change with a staff member or between two or more staff members. Staff dynamic attributes may influence how tasks are assigned, reassigned, or escalated to different staff members, how breaks are scheduled, or how breaks are executed. Staff dynamic attributes can be broadly classified into groups based on the following attributes of a staff member: capability to respond to an alarm, availability to respond to a task, current workload status, burnout or fatigue status (i.e., both current and long-term), performance (over a defined period), the management or level of support of a staff member, and the facility in which a staff member works. Dynamic attributes associated with a staff member include, but are not limited to, the examples listed in Table 2.

TABLE 10

| | | ATTRIBUTE | EXAMPLE |
|---|---|---|---|
| 1 | | a capability attribute of a staff member | |
| | a | age | 30 y/o, 60 y/o |
| | b | education | licensed practical nurse, registered nurse, |
| | | | physician |
| | c | experience | five years' of experience in an intensive care |
| | | | unit |
| | d | training | training on a specific brand of infusion |
| | | | pumps, ventilators, etc. |
| | e | frequency of training | staff member who just took the refresher |
| | | | training |
| | f | physical capability | impaired movement, not able to lift > X |
| | | | pounds |
| | g | a psychometric status of a staff member | aptitude test, skill test, personality test |
| 2 | | an availability attribute of a staff member | |
| | a | a break status of the staff member | on break, working |
| | b | a distance from the staff member to the medical | distance too far to respond to alarm |
| | | device | |
| | c | do not disturb status | working a code |
| | d | staff member closest to patient alarm | closest by feet, second closest by feet |
| 3 | | a workload attribute of a staff member | |
| | a | a number of patients assigned to the staff | 5:1 ratio |
| | | member; | |
| | b | a number of patients having a patient health | number of patients with high acuity, stability, |
| | | assessment score above a threshold | complexity, deterioration scores |
| | c | an aggregate patient health assessment score of | total scores for patients assigned to staff |
| | | assigned patients above a threshold | member |
| | d | a number of active alarms above a sub-priority | three active high priority alarms |
| | | threshold and assigned to the staff member | |
| | e | a number of scheduled tasks in current time | five active nurse calls, 4 infusions ordered |
| | | period | |
| | f | a number of potential device tasks in current | 14 active infusions assigned to current |
| | | time period | patients, 5 active infusions with critical |
| | | | medications, 10 critical devices that can |
| | | | alarm, 25 total devices that can alarm |
| | g | a patient who requires special care assigned to | patient who is at high risk for falling or |
| | | the staff member | exiting bed (e.g., combative or dementia |
| | | | patient), ventilated patient at high risk of |
| | | | extubating, etc. |
| 4 | | a burnout attribute of a staff member | |
| | a | a reported level of burnout | monthly job satisfaction score, |
| | | | in-shift emotional exhaustion score |
| | | | survey stating clinician needs a vacation or |
| | | | new job |
| | b | a grief event | divorce, death of a loved one |
| | c | a measurement of the staff member | blood pressure, number of steps, electrical |
| | | | activity of the brain indicating amount of |
| | | | sleep or activity, a lab value, a measure for |
| | | | medication compliance |
| | d | a self-reported value or activity | the number of hours slept before shift, |
| | | | medication compliance |
| | e | a work schedule | staff on overtime hours, number of shifts |
| | | | worked without a day off, number of night |
| | | | shifts per week, number of shifts before a |
| | | | vacation |
| | f | a number of hours worked per time period | number of hours worked on current shift, |
| | | | number of hours worked in last X days, |
| | | | number of hours worked since last vacation |
| | g | a percentage of time where workload status = | 90% of a staff member's shift, 80% of staff's |
| | | high | shifts in last two weeks |
| | h | a number of device tasks performed per a given | responded to 85 alarms in last 12 hours, |
| | | time period | |
| 5 | | a performance attribute of a staff member | |
| | a | a never event (per time period) | two never events in last 30 days |
| | b | a preventable adverse event associated with the | three preventable adverse events in last 30 |
| | | staff member per time period | days |
| | c | an event (per time period) | five adverse events in last 30 days |
| | d | a patient complaints (per time period) | three patient complaints in last 30 days |
| | e | an alarm response time > goal (per time period) | five high priority alarm responses > goal in |
| | | | last 30 days |
| 6 | | a management attribute of the staff member | |
| | a | a number of backups | 2 backups/staff member |
| | b | assigned as a back-up to another staff member | yes/no |
| | c | an attribute of the backups | a capability, a workload status, etc. |
| | d | an overall ratio of patients to backups | 12 to 1 |
| | e | staffing level of current shift | 60% staffed, 100% staffed |
| | f | time period of shift | shift change |
| | g | type of shift | days, nights, weekend |
| | h | hours in a shift | 8 hours, 12 hours |
| 7 | | an attribute of a facility | |
| | a | a type of facility | intensive care unit, medical/surgical floor |
| | b | a capacity of the facility | 1200 square feet |
| | c | a maximum patient-to-staff ratio of the facility | 3:1 for an ICU |
| | d | a special control in practice for the facility | need to wear personal protective equipment |
| | e | a technology available in the facility | cameras used for dementia patients to notify |
| | | | for potential fall risk |

In certain embodiments, the attributes listed in Table 2 are associated with the groups in the table. In other embodiments, attributes classified in one group, e.g., management of staff, are classified into a different group, e.g., burnout status of a staff member. For example, a conflict between two staff members working together on a shift as depicted in the attributes of the management of a staff member group can contribute to a burnout status score and be classified under this group of attributes.

As used within this disclosure, the phrase “adverse event” identifies an undesirable experience associated with the use of a medical product in a patient that could result in harm, e.g., death or injury or prolonged hospitalization, even when the care is not the cause of the occurrence.

As used within this disclosure, the phrase “preventable event” identifies an adverse event that happens, or is made possible to happen, because of either an error of commission or an error of omission made by a care provider. The error is rarely due to negligence. The error may be an inaccurate or incomplete diagnosis of a disease or an improper execution of a treatment procedure. Errors have also been attributed to issues in communication, complexity of technology used in treatment, and the use of increasingly powerful drugs.

As used within this disclosure, the phrase “never event” identifies an event that should never happen to a patient. Examples include a wrong-site surgery, a transfusion with the wrong blood type, development of a pressure ulcer, a fall, and a hospital-acquired infection.

As used within this disclosure, the phrase “grief event” identifies an event having a lasting emotional impact and can affect the staff member's ability to do their job. This may be a personal event, e.g., a divorce or loss of a family member, or a community event, e.g., loss of a coworker or closing or a portion of the hospital. The magnitude and duration of the impact, as well as the effect upon normal activities, may vary greatly. Involvement with an adverse event, particularly a preventable or never event that involves significant injury or death, can be traumatic and may cause a grief event for the staff member.

As used within this disclosure, the phrase “break status” identifies whether the staff member is on a break, i.e., temporarily not actively providing care or providing care at a reduced level. Given the long shifts often worked by staff members and the nature of the care being provided, it is important for staff members to periodically have a break. This may be indicated by the presence in a particular location, e.g., in a lunchroom (having a meal). This may also be indicated by a staff member actively indicating that they are taking a break, e.g., by changing their status on a physical tracking board or in a software program. In certain embodiments, it is desirable to avoid interrupting a break of the otherwise first-choice recipient, due to the adverse impact on that staff member, when another staff member can handle an alarm.

As used within this disclosure, the term “back-up” identifies a staff member who has been determined to have the ability to provide at least a portion of the care normally provided by another staff member. There is an expectation that the back-up will be called on only infrequently, as the back-up will have their own responsibilities. Certain back-ups, e.g., a peer or a supervisor, may be identified as a back-up for all responsibilities of a staff member. Certain back-ups may be identified as a back-up only for specific types of alarms, e.g., a technician being a back-up to a nurse only for a low battery alarm.

### Do not Disturb Status

At times, a staff member may be provided with an alert that is associated with an alarm or condition that requires an immediate response and cannot be paused to take care of a second alarm. In certain embodiments, the system and method disclosed herein assigns a Do Not Disturb (DND) status to that staff member. The DND status persists, i.e., is “active,” until it is reported that the alarm has been satisfactorily resolved. In this context, certain conditions, e.g., fire, a disaster, or severe weather, are considered interchangeable with an alarm as far as initiating an alert and are considered active until the condition is no longer present.

The system assigns a DND status based on an evaluation of one or more dynamic attributes of alarms for which an associated alert was sent to the staff member. In certain embodiments, the dynamic attributes are included in a group that comprises the number of active alarms that have a sub-priority greater than a predetermined level, the number of active alarms that require a response having a complexity equal to or greater than a predetermined level, and the number of emergency codes. In certain embodiments, the system will not send an alert for other alarms to a staff member that has an active DND status.

### Emergency Codes

Emergency codes and associated colors are defined by a health care facility to coordinate a response by staff members to situations that require immediate action. A code is declared when the event occurs. While the definition of which code color is associated with an event is not universal, exemplary guidance defines the following colors:

TABLE 3

| EMERGENCY | |
|---|---|
| CODE | MEANING |
| Red | fire (seeing flames, seeing or smelling smoke) |
| Blue | adult emergency, such as cardiac arrest or respiratory failure |
| Yellow | bomb threat; disaster |
| Gray | combative person; severe weather; security response required |
| Silver | a weapon or hostage |
| Pink | infant or child abduction |
| Orange | hazardous material accident |

An emergency code may be declared and publicly announced, for example over a public address (PA) system or broadcast electronically to multiple staff members, e.g., everyone in a building, via their personal devices, e.g., mobile phones. These actions are considered as equivalent to an alarm being issued by a medical device, an assignment of the highest priority, and provision of an associated alert to a staff member. In certain embodiments, the dynamic attributes include a location at which an emergency code has been declared and a location of the staff member and the DND status is assigned to the staff member if the staff member is within a predetermined distance of the emergency code location.

### Tasks and Breaks

Breaks are an essential aspect of working in a care facility or other high-criticality position. It is necessary to have some “down time” to rest when the routine activities require careful attention. In certain embodiments, a break comprises one or more of (a) a period of time where a staff member is not expected to perform routine, scheduled or any tasks, (b) a meal break, (c) leaving a shift early, (d) attending a training session, a counseling session, or a meeting with management or other stakeholders, (c) a grief period, (f) a period of time where a staff member is expected to sleep at or outside the facility, or (g) a period of time where non-routine tasks are performed, e.g., time to finish documentation tasks. Taking the full number and duration of scheduled breaks improves both a staff member's performance and the well-being of the staff member. Many staff members are dedicated to their jobs and reluctant to take time away unless they are certain that their responsibilities are being covered by another staff member that they trust. For example, hospital nurses are known to often skip their scheduled breaks because there is nobody assigned to take care of their patients if something happens while they are on break or they feel guilty about giving their workload to another staff member who is already overburdened with their own high workload. The responsibilities of a nurse are constantly changing, dependent upon the conditions of their current patients, and manually managing coverage so a nurse can go on break is a difficult and time-consuming task.

An automated system configured to evaluate the current workload of a nurse and determine whether assigned tasks can be “paused” without impact on the patients assures the nurse that patient care will not be compromised while the nurse takes a break. The disclosed system also provides the ability to re-assign tasks to enable a staff member to go on a break. The disclosed system also analyzes and modifies dynamic attributes, e.g. break and staff dynamic attributes, so breaks can be optimally scheduled, and more breaks can be executed on time and without interruption. Interruption of breaks is widespread and leads to clinician fatigue.

In addition, breaks laws have recently been passed in the United States, specifically the states of California, Oregon, and Washington. These states have moved to hire dedicated break nurses to cover the breaks of nurses. However, these break nurses lack a system that sends them prioritized tasks for them to complete during the break periods they cover for other clinicians. They also lack a system that optimizes break scheduling, break execution, and task reporting to ensure optimal break coverage. This system allows them to break more staff members concurrently and work shorter shifts thus saving valuable resources for hospitals. Furthermore, hiring nurses to specifically cover breaks exacerbates the nurse shortage issue in many regions.

The Task and Break Management system integrates other dedicated support staff, e.g. certified nurse assistants, and reassigns a lower-level task from nurses to support staff or escalates back up to nurses if tasks are not completed in certain time.

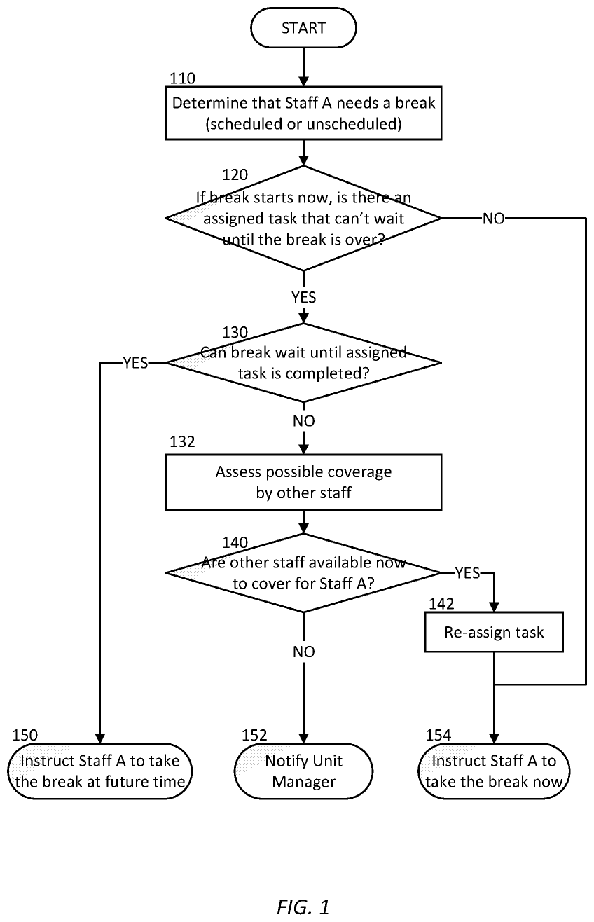

FIG. 1 depicts an exemplary workflow for managing a break for an individual, according to certain aspects of the present disclosure. The process starts at step 110 where the system determines that a staff member, designated in this example as Staff A, needs a break. In certain embodiments, a break can be a scheduled break that is retrieved from a break schedule, e.g., from a Staff Management system 1016 as shown in FIG. 10. In certain embodiments, a break is requested by Staff A for themselves, by a manager for Staff A, or by another coworker for Staff A. In certain embodiments, the system determines an unscheduled break based on one or more of hospital policies, local, state, or national compliance requirements, or best practices to combat fatigue and sleep debt. In certain embodiments, the system retrieves the staff dynamic attributes of a staff member and determines that a break is needed. In certain embodiments, the system reviews attributes associated with workload and fatigue and determines that a break is needed because a staff member has worked too many hours in a specific time period. In certain embodiments, the system reviews attributes associated with workload and fatigue and determines whether an unscheduled break is needed based on rules to reduce the risk of an adverse event. In certain embodiments, a break comprises a reduction of tasks assigned to a staff member for a period of time. For example, a staff member may receive a break to finish documentation for their shift but still be eligible to be assigned a particular type of task, e.g., an ad hoc task to respond to an alarm, while on this “documentation break.”

Step 120 determines whether Staff A has an uncompleted assigned task that cannot wait to be completed until a break that starts now is over. In certain embodiments, there is a task list associated with Staff A and each task has one or more attributes, e.g., the task must be completed by a defined time or the task has an estimated time-to-complete duration. The system determines whether a task can be deferred until after the determined break by comparing the expected task durations with the break start time and duration. In certain embodiments, the system determines whether the task can be deferred by the priority assigned to the break. In certain embodiments, only critical tasks, e.g., tasks that have been assigned a priority above a threshold, are considered to determine if Staff A can take a break. In certain embodiment, some tasks may be defined or configurable as not to be reassigned based on hospital, unit, or staff policies or preferences. For example, some nurses prefer to perform their own medication titrations.

In certain embodiments, the list of tasks assigned to a staff member pulls tasks associated with the patients assigned to the staff member from various sources, e.g., a medical device 1022, a pharmacy system 1014, an electronic health records (EHR) 1010 of FIG. 10. In certain embodiments, tasks are manually assigned to staff members, i.e., added to the task lists of the staff members.

If step 120 determines there are no tasks that need to be completed during the break period, the process branches to step 154 that instructs Staff A to take the break now. In certain embodiments, the break starts immediately upon this instruction. In certain embodiments, the system instructs Staff A when to start the break. In certain embodiments, the system provides an advanced notification to Staff A that their break will start in X minutes in step 154 prior to performing the task analysis of step 120. For example, the advanced notification alerts the clinician that their break starts in 10 minutes and determines if the staff member should finish any tasks before they take the break.

If step 120 determines there are tasks that need to be completed during the break period or during the advanced notification window, then the process continues to step 130 where the system determines if the break start time can be delayed until the assigned task is complete. In certain embodiments, a variable time-based critical task (e.g. a nurse performing a drug titration, working a code, etc.) does not allow a clinician to take a break during the defined start time. In certain embodiments, a clinician may enter an input to indicate they cannot take a break at the scheduled start time. For example, they may decline the break notification task on their mobile phone, or state they cannot take a break via a voice activated device. In other embodiments, if the clinician does not accept a break during an advance notification window and the system knows there is a critical task on their task list, then the system will not start the break and reassess the revised break start time at a later time.

If step 130 determines the break can wait until an assigned task is completed, then the process branches to step 150 and instructs Staff A to take a break at a future time that allows enough time to complete the conflicting task. In certain embodiments, the system provides a notification that Staff A may start their break within a range of times in the future. In certain embodiments, the staff member's manager may designate that the break needs to be taken at the defined start time. In certain embodiments, the rules covering when breaks need to start are predefined in configurable settings and rules, e.g., defined by a hospital administrator in the Task and Break Management system 1040 of FIG. 10.

If step 130 determines the break cannot wait until the task is completed, then the process branches to step 132 that assesses coverage by other staff members. In certain embodiments, the system retrieves the staff dynamic attributes of other staff members and determines who is qualified to perform the task. In certain embodiments, the system retrieves the workload or task list of other staff members and determines who has the bandwidth to perform the task within the required time window. The process then continues to step 140.

Step 140 determines whether there is an available staff member to whom the task can be reassigned. In certain embodiments, the system retrieves staff dynamic attributes of the other staff members on the unit and determines who should be reassigned the task. In certain embodiments, the system determines whether there are dedicated resources who can perform the task, e.g., a break nurse, or if the other staff members working the unit can perform the task. If there are staff members available to perform the task, the process branches to step 142 wherein the task is reassigned and then step 154 instructs Staff A to take the break.

If step 140 determines there are no available staff members to whom the task can be reassigned, the process branches to step 152 wherein the unit manager is notified that the task could not be reassigned and the break could not be deferred such that Staff A was not able to take their assigned break. In some embodiments, the system logs these notifications and provides a signal if these notifications exceed a threshold. In some embodiments, the system provides managers with configurable options on how they want to be notified.

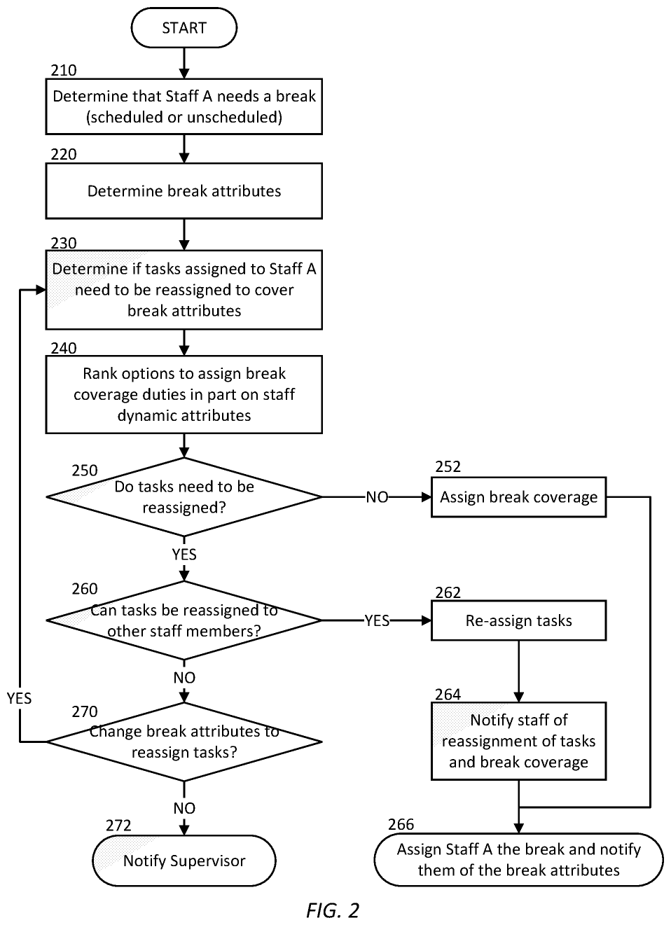

FIG. 2 depicts an exemplary alternate workflow for managing options for giving a staff member a break, according to certain aspects of the present disclosure. The process starts at step 210 wherein the system determines that Staff A needs a break.

The process continues to step 220 where the Task and Break Management system determines the dynamic attributes of the break. In certain embodiments, the break dynamic attributes comprises one or more of a start time, a duration, a break type, e.g., a meal break or a training session, a break priority, a second staff member to share the break with, a location of the break, an item to bring to break, e.g., training material, and what type of tasks to reduce and what type of tasks to still assign. In a first example, the system determines the attributes of a break for Staff A comprise that this is a lunch break, the duration is 60 minutes, the break starts in 15 minutes, and Staff B is to share this break with Staff A. In a second example, the system determines the break dynamic attributes comprise that this is a 1-hour training session at 2 PM in Training Room A, and Staff A is to bring training material. In a third example, Staff A is not feeling well, and the break duration attribute needs to account for the last six hours of their shift.

At step 230, the Task and Break Management system determines whether any tasks assigned to Staff A need to be reassigned to other staff members to execute the break dynamic attributes. The process proceeds to step 240 where the system determines options to reassign tasks, if any tasks need to be reassigned, and ranks them. In certain embodiments, the system determines if tasks can be reassigned to other staff members per their staff dynamic attributes. For example, the system determines if other staff members are available and capable of performing the tasks and do not have a workload status, burnout status or performance status that prohibits them from taking on additional tasks. For example, the system will not reassign the task to a particular staff member if it increases the probability of an adverse event above a threshold. In certain embodiments the system prioritizes reassigning tasks to the lowest level of staff that is trained to perform the task.

In certain embodiments, the system will only provide options that reassign certain tasks but not others. In certain embodiments, only critical tasks or tasks associated with the admit, discharge, and transfer (ADT) goals of the facility are reassigned to other staff members. In certain embodiments, tasks are categorized in the Task and Break Management system, e.g., a list of tasks that cannot be reassigned. In certain embodiments, the system maximizes the number of staff members that a dedicated break nurse covers within a time period by identifying options where some tasks are assigned to the break nurse and other tasks are assigned to other staff members, e.g., a technician. In certain embodiments, an option that enables a break nurse to cover for more staff members while limiting reassignment of tasks to other staff members with assigned patients are ranked highest.

In certain embodiments, the system comprises rules to ensure compliance with regulations. For example, some state regulations specify maximum pre-defined patient/staff ratios. Some regulations allow patient tasks to be split between one or more staff members to ensure flexibility in interpreting the maximum allowed patient/staff workloads.

In certain embodiments, the system will consider staff members who are not currently working the shift and determine options that best consider the staff dynamic attributes of these staff to reassign the tasks. For example, these other staff members may be “float staff,” work in a different unit, on-call, assigned to work the next shift, remote, and from staffing agencies. In certain embodiments, the system will first prompt the supervisors to call in the additional resources before reassigning tasks.

In step 250, the system determines if, based on availability of additional staff, there are still tasks be reassigned to other staff members. If tasks must be reassigned, the process branches to step 252 that reassigns the tasks then progresses to step 266 wherein the system assigns Staff A the break. In certain embodiments, these staff members receive a communication that notifies them that an imminent critical task has been reassigned to them and they need to perform the task immediately. In certain embodiments, the staff receive a notification that new tasks have been reassigned and the tasks are in their task assignment list. In certain embodiments, the assigned and reassigned tasks will appear in a task management list that is located on a mobile phone application, a desktop application, a digital whiteboard, or a digital screen located in a patient room, a hallway or a central location.

In certain embodiments, step 250 determines that there are no current tasks that need to be reassigned but makes a determination that potential ad hoc tasks may occur during the break period and branches to step 252.

In certain embodiments, the assignment of the break prevents other tasks from being assigned to Staff A during the break duration. In certain embodiments, ongoing tasks can still be assigned to Staff A during their break as long as the tasks may be performed after the break is over. In certain embodiments, the system notifies Staff A to whom their critical tasks were reassigned to and acknowledgment that the other staff member accepted the reassigned task. For example, if Staff A requested a 20 min break to occur immediately and they had to administer a critical medication ten minutes into such break, the system will notify them that Staff C accepted the assignment to perform the critical medication administration. In certain embodiments, Staff A receives another notification that the critical medication was administered.

If step 250 determines that at least one task needs to be reassigned to another staff member, the process branches to step 260 wherein the system determines which staff members are qualified and available to accept each task. If the task can be reassigned, the process branches to step 262 that reassigns the task, step 264 that notifies the staff members receiving the reassigned tasks, and step 266 that notifies staff A to take the break.

If there are tasks that cannot be reassigned in step 260, the process branches to step 270, which evaluates possible changes in the break dynamic attributes, e.g., start time. If an attribute can be changed, the process branches back to step 230 to reevaluate what task need to be reassigned.

If step 260 determines the break dynamic attributes cannot be modified and, therefore, it is not possible to reassign tasks to cover the initial break dynamic attributes, then the process proceeds to step 262 and notifies the supervisor.

In certain embodiments, the system provides the supervisor the best options to provide the break to Staff A, the break dynamic attributes for this period, and what tasks cannot be assigned to other staff members. In certain embodiments, the system asks the supervisor if they can personally cover the one or more tasks that cannot be covered by the other staff and, if so, the system will reassign the one or more tasks and notify the parties (steps 252, 262, and 266).

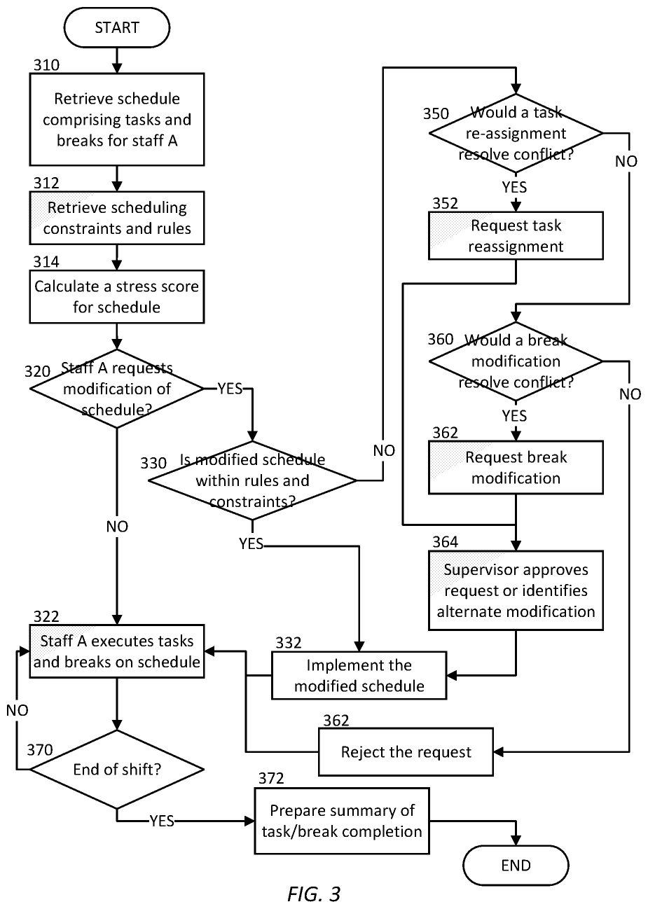

FIG. 3 depicts an exemplary workflow for enabling a staff member to control their own break schedule, according to certain aspects of the present disclosure. Steps 310, 312, 314 retrieve one or more of assigned tasks, assigned breaks, and a schedule for staff A and calculates a fatigue score for this schedule for staff A. In certain embodiments, the fatigue score is calculated from one or more of hours worked in the most recent time period of a defined length, the number of hours worked continuously immediately prior to the current time, the time since a last break, the number of patients currently assigned to the staff member, the number and/or complexity of currently assigned tasks, an assessment by a supervisor or other staff member, and results of a questionnaire/assessment document.

In step 320, Staff A requests a break at a proposed start time with a proposed duration. In certain embodiments, the request comprises one or more of changing the current break start time to a proposed start time, changing the break duration to a proposed duration, and ending a current work shift at a proposed time.

Step 330 determines whether the requested break complies with rules and constraints defined in the system and, if compliant, implements the requested change in step 322. If the requested change is not compliant, e.g., a task would not be completed within the allowed time window, the process branches to step 350 that determines whether a task reassignment will resolve the conflict. If a reassignment is identified that will resolve the conflict, the reassignment is requested in step 352 and presented to the supervisor, who approves the reassignment or identifies an alternate modification in step 364. If step 350 cannot identify a task reassignment that resolves the conflict, the process branches to step 360 to determine a break modification that would resolve the conflict. If a modification is identified, the modification is requested in step 362 and again forwarded to the supervisor for review in step 364. If there is no break modification that will resolve the conflict, the system rejects the requested schedule modification in step 362.

In the absence of an action by staff A in step 320, the process proceeds to step 322 wherein staff A executes the schedule, performs the assigned tasks, and takes the assigned breaks until the end of shift in step 370. In certain embodiments, step 372 prepares a summary of tasks and breaks that includes whether the tasks were completed and the breaks taken.

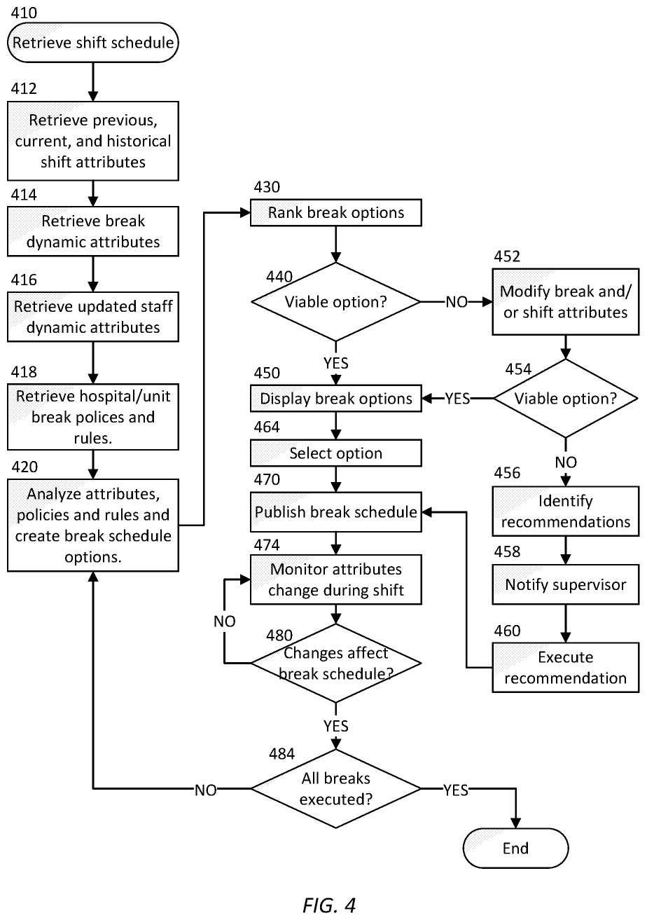

FIG. 4 depicts an exemplary workflow for managing a break schedule for staff members in a care unit, according to certain aspects of the present disclosure. The Task and Break Management system retrieves the shift schedule for the shift that the break schedule needs to be created, shifts attributes from one or more of the previous, current, and historical shifts, break dynamic attributes, staff dynamic attributes, and policies and rules in steps 412, 414, 416, 418. In certain embodiments, the shift schedule can be imported from a staff management system, e.g., a scheduling program. In other embodiments, the shift schedule is manually entered by a staff member. Shift dynamic attributes are defined as attributes that can change on a shift or between one shift and another and include one or more of staffing, shift hours, type of shift (e.g., day shift or night shift), ADT information, type and severity of medical conditions treated, patient/staff assignments ratios, acuity of patients, stability of patients, number of overtime (OT) hours scheduled and/or worked by staff on a unit, availability of support staff (e.g., certified nursing assistants and/or break nurses), number of breaks to be scheduled, breaks hour to be scheduled, number of breaks missed or interrupted on a prior shift, community events near hospital during shift, and weather and traffic events during shift. In certain embodiments, shift dynamic attributes include outstanding tasks that need to be carried over from the previous shift to the shift being planned. Break dynamic attributes comprises one or more of break type, duration, priority, break start time, number of breaks per clinician per shift, and staff break preferences. In certain embodiments, staff dynamic attributes comprise an item in Table 2 or one or more of staff who are working the current shift, staff who worked the previous shift and who were asked to continue working the current shift, and staff who are currently not working or are working at different units, e.g. float nurses, that can be called in to work the shift being planned.

The method proceeds to step 420, where the Task and Break Management system analyzes the shift, break and staff dynamic attributes, break policies and rules, and staff break preferences and creates different break schedule options. In certain embodiments, the various attributes are weighted. The process proceeds to step 430 wherein the system ranks the different options. In certain embodiments, the system will prioritize rules and analyze the weights of the applicable dynamic attributes associated with the prioritized rules to create higher-ranking break schedule options. In other embodiments, there are hard constraints that may not be violated. For example, meal breaks can be as long as one hour but cannot be less than 30 minutes per state regulations. In certain embodiments, the combination of hard rules and weighted scores for dynamic attributes will determine ranking for break schedule options.

Step 440 will determine if there is a viable option among the different ranked break schedule options. In some embodiments, some options are not viable because the break management system is unable to schedule all the breaks or schedule all the breaks with the required break dynamic attributes. For example, inadequately staffed shifts with high patient workloads will not have a viable break schedule option because not everyone will be able to take their breaks per their break dynamic attributes.

If there is a viable break option, then the break management system will proceed to step 450. In step 450, the break management system will display the break schedule option rankings to managers and administrators. In certain embodiments, each break schedule option is ranked with a score between 0 to 100, with a scoring system that defines different scores ranges by acceptability and indicates the acceptability visually on a user interface. For example, from 0 to 100, any score less than 50 is not acceptable and the break management system will display the score with red font, an unacceptable designation, or both. In other embodiments, the break schedule options with the highest ranking are shown on the top of the user interface and the lower ranked options are shown at the bottom of the user interface or not at all. In other embodiments, the system will generate a break management schedule and indicate which breaks have a low confidence of occurring.

In step 464, the manager or the break management system selects the break schedule option to publish for the unit. In certain embodiments, the Task and Break Management system selects an option and proceeds to step 470. In other embodiments, a manager selects the option or approves the selected option at step 464 and then the system will publish the schedule at step 470. In certain embodiments, the manager approves a partial break schedule where one or more clinician breaks need to be filled. In certain embodiments, the manager approves a partial shift break schedule, e.g., just the morning breaks. In certain embodiments, the break schedule is published on one or more display devices in the unit, e.g., mobile phones, desktop applications, and/or digital whiteboards.

If there is no viable break schedule option in step 440, the process branches to step 452 and modifies one or more dynamic attributes, e.g. a break dynamic attribute or a shift dynamic attribute. In certain embodiments, the first attempt at creating a break schedule option will consider the maximum value of a break dynamic attribute. In an example wherein regulations require a meal break to be at least 30 minutes in duration and hospital policy is to provide a 60-minute meal break, then step 452 decreases the meal break duration, with a minimum of 30 minutes, to identify a viable break schedule option.

In certain embodiments, the initial break schedule creation will not consider certain shift dynamic attributes, e.g., the use of a dedicated break nurse. If this constraint does not identify a viable option, then step 452 will add a dedicated break staff member and re-evaluate the options. This method allows a unit manager to determine how long they may need to keep a dedicated resource to cover the breaks of the shifts.

Step 454 will determine if there is a viable option after the modifications. If yes, then the method will proceed to step 450 and display the break options. If no, then the Task and Break Management system will identify recommendations in step 456 to create a viable break schedule. For example, a recommendation may include advising a charge nurse to cover breaks for 30 minutes during the morning breaks, recommending a dedicated break nurse be used from 11:00 AM to 2:00 PM, or calling in a staff member who works the next shift to come in one hour early. In step 458, the break management system will notify the supervisor that there are not viable break schedule options, provide the reason, and display the identified recommendations.

The supervisor can execute one of the recommendations in step 460. In certain embodiments, the user interface may provide options to select on the screen which will implement the recommendation. Once the recommendation is implemented then the break management system proceeds to step 470 and publishes the break schedule. In other embodiments, the recommendation cannot be executed completely by the Task and Break Management system. For example, the recommendation may be to bring in extra staff members but it takes time for the extra staff member to clock in and, in certain embodiments, the break management system publishes the break schedule in step 470 with color codes indicating breaks that can be taken without the recommendation and breaks that be taken with the recommendation. In certain embodiments, the recommendation is displayed in the schedule with the applicable color coding.

In certain embodiments, the Task and Break Management system will continuously monitor the dynamic attributes in step 474 and update the break schedule if warranted. In certain embodiments, the system will monitor the staff, shift, patient and break dynamic attributes. For example, if the fatigue score changes for a staff dynamic attribute, the break priority will change for this clinician, and the break management system will look to schedule this break sooner. In another example, staff members are added or subtracted to a unit and the applicable shift dynamic attribute changes causing the break management system to modify the break schedules or identify recommendations for the manager. In certain embodiments, a clinician requests a break and the system accommodates the break if the manager approves the request.

When a system detects a shift, break, patient or staff dynamic attribute change, step 480 determines if the change is significant enough to affect the break schedule. In certain embodiments, there is a subset of attributes that can affect break schedules and there are thresholds that determine if the attribute change is significant enough to affect a break schedule. In certain embodiments, the determination for whether an attribute change is significant enough depends on how much time is remaining on the shift, if breaks have been executed or if there have been missed/interrupted breaks that need to be rescheduled. For example, if there is one hour left in the shift and there are only a few 15-minute breaks to execute on, then the system may determine most changes are not significant compared to if the evaluation was made earlier in the shift.

If step 480 determines the attributes changes do not affect the break schedule, then the system returns to step 474 and continues monitoring for attribute changes. In certain embodiments, the dynamic shift and/or break dynamic attributes change as staff members enter information into the system for events, e.g. break completion. If the break schedule is affected, then the system branches to step 484 and determines whether all the breaks have been executed for the shift. If step 484 determines that all the breaks have been taken on the shift, the process ends. If some breaks have not yet been completed, then the process returns to step 420 and reanalyzes the break schedule.

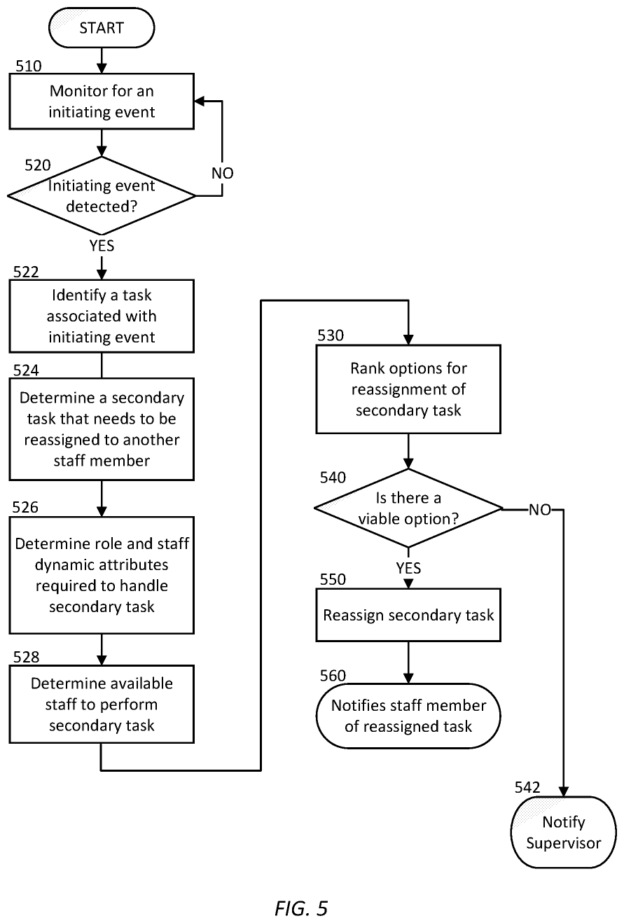

FIG. 5 depicts an exemplary workflow for assigning a task in response to an initiating event, according to certain aspects of the present disclosure. As used in this disclosure, the phrase “initiating event” refers an event where one or more clinicians cannot take any tasks (e.g., a clinician taking a break, going home early, attending a training session etc.) or an event where one or more clinicians can only take tasks from one patient over set amount of time (e.g., working a code, patient-sitting a patient who requires special 1:1 care per hospital policy) when they normally are assigned more than one patient. An initiating event requires that the tasks associated with all the patients assigned to a clinician or the tasks associated with all the patients except one patient be reassigned to another clinician since the primary clinician is not available to perform these tasks.

The process starts at step 510, where the Task and Break Management system monitors for the presence of an initiating event. In certain embodiments, the application receives a notification of an initiating event from another hospital system via a communication protocol. For example, a nurse call station can communicate a code blue event. In certain embodiments, a clinician, remote clinician, or a staff member can enter an initiating event into the Task and Break Management system. For example, a charge nurse can create a task that requires a clinician to patient sit a patient for the next hour. In certain embodiments, the Task and Break Management system determines a break schedule for a staff member is scheduled in 15 minutes and needs to be executed.

The process proceeds to Step 520 where the Task and Break Management system determines if the input received qualifies for an initiating event. In certain embodiments, the system allows the hospital to create rules to define an initiating event. For example, an administrator creates a rule that consider the attributes of the event, e.g., duration and severity, patient dynamic attributes of the patients assigned to a clinician, e.g., patient acuity, and staff dynamic attributes of the clinician, e.g., patient assignment load. The administrator can define rules so an initiating event is detected if Clinician A has to address a code but has a high workload, e.g., other patients assigned, with high patient acuities.

If an initiating event is not detected, then step 520 returns to step 510 and continues to monitor. If an initiating event is detected, then the process proceeds to step 522 and identifies the secondary tasks associated with the initiating event. As used in this this disclosure, the phrase “secondary task” is a task not associated with the initiating event but are associated with the tasks that the clinician cannot perform when they are performing the initiating event. For example, when a clinician is on break or working a code, they may have secondary tasks associated with other patients assigned to them that require care, e.g., medication administration or vital sign monitoring.

Step 524 determines which secondary tasks should be reassigned to another staff member. In certain embodiments, the system determines which tasks need to be reassigned based in part on a patient dynamic attribute associated with the tasks, e.g., patient acuity. In certain embodiments, the tasks that need to be reassigned based on the task priority and attributes of the initiating event, e.g., duration. For example, high and medium priority tasks that need to be completed before the initiating event ends would be reassigned. In certain embodiments, a break nurse who is covering breaks for multiple clinicians receives tasks reassigned that are prioritized based on the dynamic attributes from multiple initiating events.

The process proceeds to step 526 and determines the role and staff dynamic attributes required to handle the secondary tasks. In certain embodiments, the Task and Break Management system determines the training required to perform a task and will consider the type of medical device or therapeutic, the type of procedure and if it is specific to the hospital or the hospital unit, and any new safety information from the manufacturer, e.g., new way to perform a task on a device based on a recall. If the staff member does not have the proper training, the Task and Break Management system will not reassign the secondary task to that staff member.

Step 528 determines who is available to perform the tasks. In certain embodiments, a clinician on break is not available. In certain embodiments, a staff member who is on one initiating event, e.g., break, may need to be summoned back to perform secondary tasks for a clinician on another initiative event, e.g., participating in a code. Step 530 ranks the options for reassignment of secondary tasks. In certain embodiments, the system ranks staff members based on one or more of their staff dynamic attributes. For example, the Task and Break Management system determines what training is required to perform a task and will not assign a task to a new staff or float member who is not trained on the task. In certain embodiments, the patient dynamic attribute and the staff dynamic attribute are considered. For example, Staff A may lack the training but, due to their education and the staff dynamic attributes of the other staff and the acuity of the patient associated with the task, the task is still reassigned to Staff A.

Step 540 determines if there is a viable option and, if no, then step 542 notifies the supervisor. In certain embodiments, the system notifies the supervisor of the initiating event, the secondary tasks that cannot be reassigned, the task priority and information to identify the patient and patient location.

If step 540 determines there is a viable option, then step 550 reassigns the secondary tasks. The process ends with step 560 and notifies the staff members of the reassigned tasks. In certain embodiments, the staff member who is receiving the reassigned task receives the assignment on a notification device (e.g., mobile phone, voice activated device, central workstation). In certain embodiments, the receiving clinician's task list is updated to reflect the reassign secondary tasks with the reassigned task, task priority, applicable notes and information to identify the patient, patient location, and the staff member who was originally assigned the task. In certain embodiments, the staff member who is performing the initiating event also receives a notification. For example, they receive a message on a display device or their task list is updated to state the status of the secondary task, who performed it, the time they performed it, and any applicable notes.

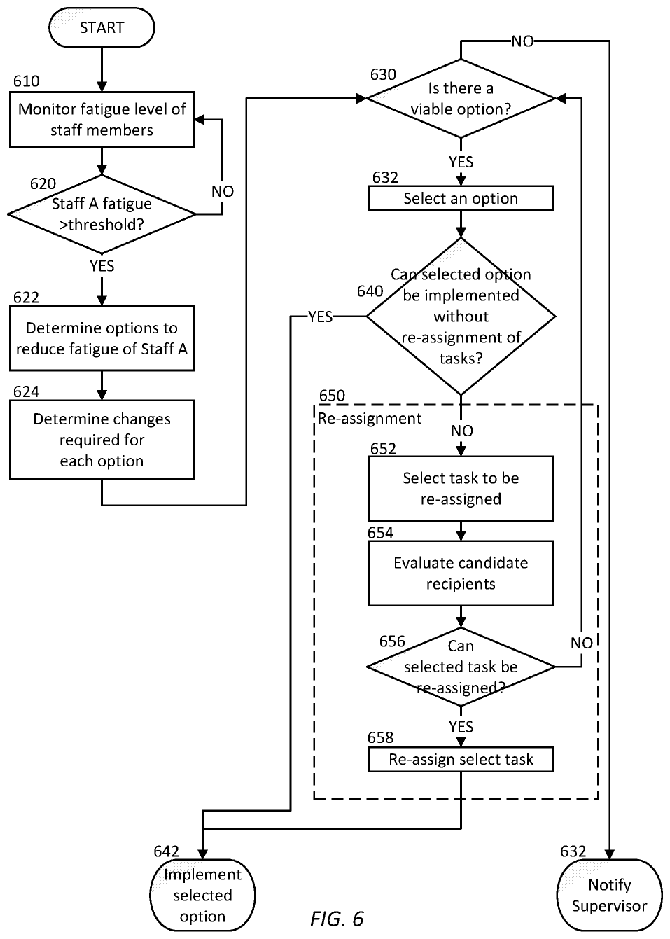

FIG. 6 depicts an exemplary workflow for reducing fatigue in a staff member, according to certain aspects of the present disclosure. The process starts with step 610 that monitors the fatigue level of the staff members, e.g., using a self-administered questionnaire or a supervisor assessment, that is compared to a threshold in step 620. In some embodiments, monitoring comprises analyzing the work schedule of the staff member to understand how many shifts and hours they have worked in a given time period. In certain embodiments, monitoring the burnout or fatigue staff dynamic attribute of a staff member and determining if a threshold is exceeded determines if staff fatigue should be mitigated.

If a staff member is found to be fatigues in step 620, the process proceeds to determine options to reduce that staff member's level of fatigue, determine what changes are required for each option, and determine whether there is a viable option in steps 622, 624, and 630. If there is no viable option, the process notifies the supervisor in step 632. If there is at least one viable option, the process proceeds to step 632 and selects one option to evaluate in step 640 as whether that option requires reassignment of a task. If a reassignment is not required, the selected option is implemented in step 642. If a reassignment is required, the process proceeds to block 650 wherein steps 652, 654 select a candidate task and determine whether the candidate task can be reassigned. If the candidate task can be reassigned, the process reassigns the task in step 658 and implements the selected option in step 642. If the candidate task cannot be reassigned, the process loops back to step 630 reconsider the options. In certain embodiments the process branches first from step 656 to step 652 to select other candidate tasks and only branches back to step 630 if no task is found to enable the selected option.

In certain embodiments, options to reduce fatigue comprise one or more of reassigning a task, reducing certain types of tasks, reducing distance between tasks, e.g., reducing the walking, sending the staff member on a break, modifying the break attribute to give them a longer break or a sleep break, sending the staff member home early, and reducing the number of patients assigned to the staff member.

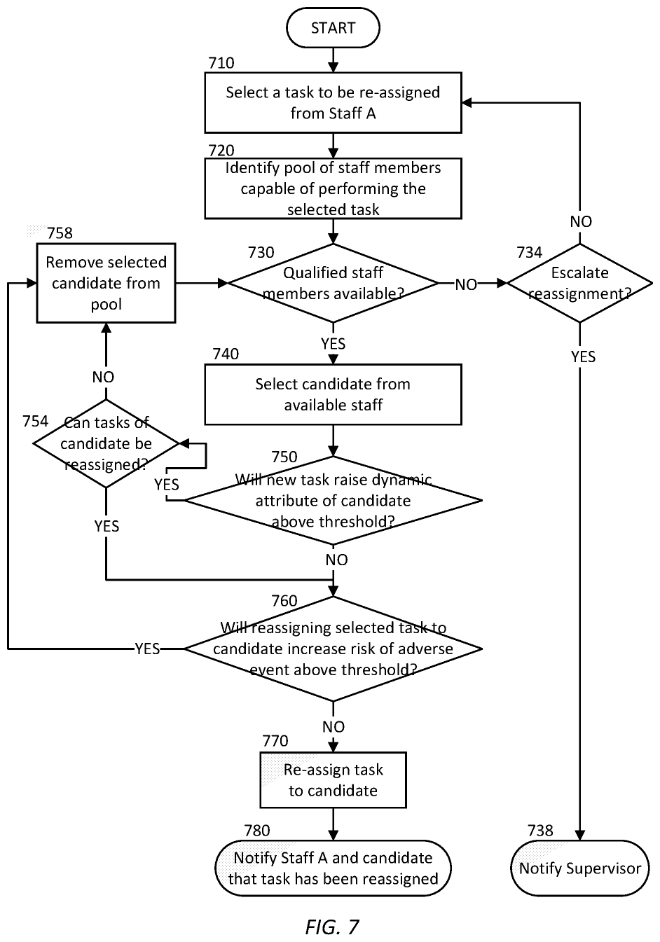

FIG. 7 depicts an exemplary workflow for re-assigning a task from one staff member to another staff member, according to certain aspects of the present disclosure. This example presumes that a task must be reassigned from Staff A to another staff member. The process starts at step 710 when the Task and Break Management system selects a task to be reassigned from Staff A. For the purpose of this example, the method of selection are not important. In step 720, the system determines a pool of staff members capable of executing the selected task. In certain embodiments, each task is prioritized by severity and level of skill, e.g. education and/or experience, required to perform the task and the system determines which staff have the requisite staff dynamic attributes. For example, certain medications may only be administered by a nurse or a doctor. From this pool of capable staff members, step 730 determines which staff members are available to perform the task. In certain embodiments, availability is based on one or more of whether they are currently working, whether they are on a break, whether they are on a DND status, or whether they are located at a distance that prohibits them from responding in a timely or reasonably fashion. In certain embodiments, the location of the staff member is determined by a Real Time Locating System (RTLS) that tracks the staff member, e.g., by sensing the location of one or more of the staff member's badge and their personal communication device, or a passive system, e.g., facial recognition from surveillance cameras that are static or attached to a moving platform within the hospital.

If step 730 determines a qualified staff member is not available for the task that requires reassignment, then the process proceeds to step 734 to determine if the escalation time period for reassignment has been escalated. If yes, then the system will notify the supervisor in step 738. If no, then the system will continue to step 710 and continue to cycle through steps 710, 720, 730 to find an available qualified staff member or step 734 determines the reassignment needs to be escalated.

If step 730 determines one or more qualified staff members are available, then step 740 will select a candidate. In certain embodiments, the system preferentially selects a staff member pre-assigned to support Staff A, e.g., a “buddy nurse.” In certain embodiments, the system ranks the available staff members by one or more of their staff dynamic attributes and initially selects the highest ranked staff member. In some embodiments, the dynamic attribute score used to rank the best candidates is a weighted average of the individual scores of the staff dynamic attributes.

Step 750 determines if reassigning this new task or set of tasks to the candidate will cause one or more of the candidate's dynamic attribute score to exceed a threshold. If no, then step 760 determines if reassigning the task to the candidate will cause the risk of an adverse event to increase above a threshold. In certain embodiments, the risk of an adverse event is based in part on one or more of a fatigue level, the role of the staff member, the tasks that are currently assigned to the staff member, a dynamic attribute of a patient assigned to the staff member, and a dynamic attribute of the staff member. If no, then step 770 will reassign the task or set of tasks from Staff A to the candidate and notify both Staff A and the candidate that the task has been reassigned from in step 780. In certain embodiments, steps 750 or 760 is omitted from the process. For example, a break nurse may be reassigned tasks from a physician going on break.

If step 750 determines the reassignment of the task will increase the candidate's dynamic attribute score above a threshold, then step 754 will determine if a task originally assigned to the candidate can be reassigned to another staff member so the candidates dynamic attribute score will stay below the threshold. In certain embodiments, the selection of which tasks from the candidate is accomplished using the process of FIG. 7. If tasks cannot be removed from the candidate's task list to accommodate reassignment of the task from Staff A, then step 758 removes Staff B from the candidate pool then proceeds to step 730 to determine if there is another staff that is qualified. In certain embodiments, there are timers built in for how long a task can remain not completed before escalating to another staff member or a unit manager. In certain embodiments, a high sub-priority task assigned to Staff A is reassigned to the unit manager if no qualified staff members are identified.

If step 754 determines tasks can be reassigned from Staff B, then the process proceeds to step 760 and determines if reassigning the task or set of tasks from Staff A to the candidate increases the risk of an adverse event above a threshold. In certain embodiments, one or both of steps 750 and 760 are omitted. If step 750 determines the adverse event risk threshold is exceeded, then this candidate is removed from the candidate pool in step 758. In certain embodiments, a staff member may be allowed exceed an adverse event risk threshold under special conditions, e.g., they are caring for a patient with an infectious disease and the task being reassigned is associated with a patient who is immunocompromised.

If step 760 determines the adverse event threshold is not exceeded, then the system proceeds to step 770 and reassigns the task or set of tasks to the recipient candidate. Step 770 proceeds to step 780 where the system notifies Staff A that their tasks have been reassigned and notifies the candidate of the reassigned task. In certain embodiments, the respective tasks lists of Staff A and the candidate staff member are updated. In certain embodiments, the recipient candidate receives notifications of the tasks, task priority, information identifying the patient and location, and any applicable notes related to the reassigned task.

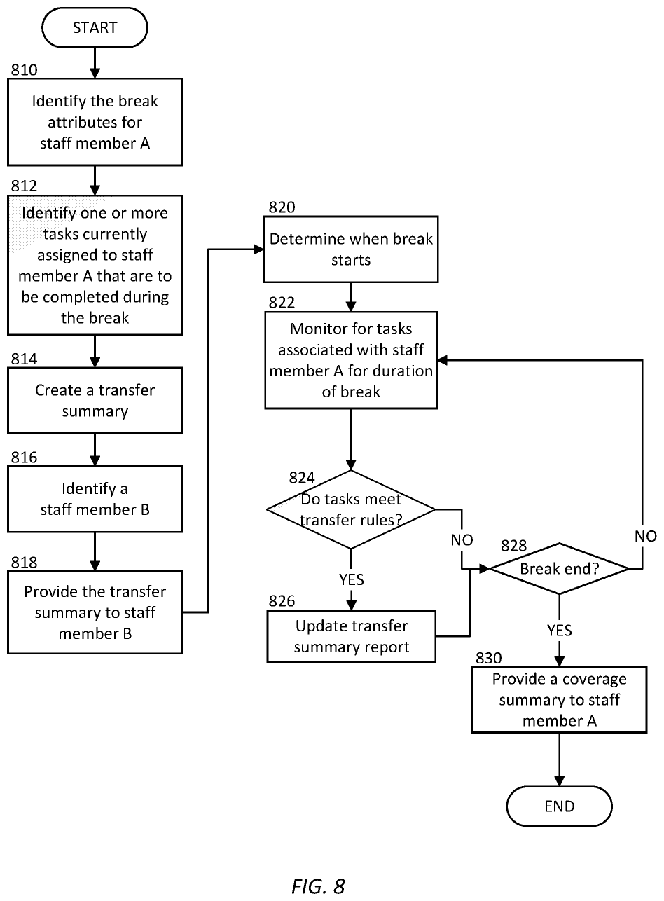

FIG. 8 depicts an exemplary workflow for handing off tasks from one staff member to another staff member, according to certain aspects of the present disclosure. The process starts with step 810 where the Task and Break Management system identifies the break dynamic attributes for staff member A, who is going on break. In certain embodiments, the system pulls one or more break dynamic attributes, e.g., the break start time and break type and break priority and break duration, from the break schedule. In certain embodiments, one or more of these attributes is pulled from a break execution module where the break dynamic attributes may need to be modified in order to execute a break from the break schedule. In certain embodiments, one or more break dynamic attributes are manually entered by a clinician, manager or administrator.

The process proceeds to step 812, and the system identifies one or more tasks that are currently assigned to staff member A that are to be completed during the break. In certain embodiments, the break management systems pulls tasks from staff A's task list that need to be completed by analyzing and comparing one or more task dynamic attributes, e.g., task duration and task expected completion time and task priority, with the break dynamic attributes, e.g., break start time and duration. In certain embodiments, the break type dictates the type of tasks that should be performed during the break by the clinician covering the break, e.g., a break nurse.

In certain embodiments, step 812 identifies possible future ad hoc tasks that have not occurred but would need to be addressed during the break. For example, a task may be created to respond to a medical alarm.

Step 814 creates a break transfer summary report that will be provided to staff member B to inform them of what tasks need to be performed or covered during staff member A's break. In certain embodiments, the break summary report comprises one or more patient dynamic attributes, staff dynamic attributes, task dynamic attributes, and/or break dynamic attributes, e.g., patient identification information, patient location, a task to be completed, a task priority, an expected completion time for a task, and notes from Staff A. In certain embodiments, a break coverage staff member, e.g., a break nurse, covers tasks from multiple staff members taking a break so a break transfer summary report will also identify each staff member who is going on break and their contact information. In certain situations, there are no planned tasks to put on break transfer summary report for a particular patient but there will be a requirement for the coverage staff member to address any ad hoc tasks associated with the patients of the staff on break.

Step 816 identifies a staff member B who will perform the tasks when staff member A goes on break. In certain embodiments, Staff B comprises one person. In other embodiments, Staff B is more than one person and more than one different role. FIG. 7 discusses how the Task and Break Management system identifies staff members to be reassigned tasks.

Step 818 sends the break transfer summary report to staff member B. In some embodiments, the break management system sends this report to various user interface devices and personal communication devices in the hospital, e.g., mobile phone, desktop application, or digital screen outside or inside a patient's room. In certain embodiments, the break coverage staff member receives a notification that they received new information about staff member A going on break and they can see the new tasks when their task list is updated. In certain embodiments, there is a separate task list associated with staff member A that is sent to staff member B's mobile phone. In certain embodiments, staff member B has one task list associated with all the tasks they need to cover. In certain embodiments, staff member B has separate task lists associated with all the staff members they are covering breaks. In certain embodiments, specific categories of tasks, e.g., high priority tasks, are sent as notifications to staff member B as well as an updated task list.

In Step 820, the Task and Break Management system determines when the break starts. In certain embodiments, a break execution module determines the actual break start time when it executes the break schedule for a particular break. For example, staff member A and B each acknowledge the break start time on a user interface and the break execution module tracks the time. In other embodiments, step 820 starts a few minutes before the break starts in an advance notification window as defined in configurable settings in the break execution module.

Once the break starts in step 822, the Task and Break Management system monitors for new or revised tasks associated with the patients that staff member B is covering for staff member A. New or revised tasks can originate from medical devices, e.g. an alarm, other staff members, e.g., a doctor's orders, or other hospital systems, e.g., the pharmacy system, laboratory system, or ADT system.

In step 824, the system determines if any new or revised tasks meet the task transfer rules. Task transfer rules define which new or revised tasks should be covered by the break coverage staff member during the break and which tasks can wait and be addressed by staff A when they come back from break. In certain embodiments, new or revised tasks satisfy break transfer rules and are updated on the break transfer summery report based on the task, task priority, expected completed time of task, and time left on the break. In certain embodiments, the priority of the tasks indicates the urgency with which a task needs to be completed can be the main determining factor for what tasks needs to be completed before the break coverage period ends and therefore added to the break transfer summary report.

In certain embodiments, the task transfer rules incorporate the staff dynamic attributes of the staff members providing the break coverage. For example, a medium or low priority task does not get transferred to the break transfer report if the remaining time of the break is short and the break coverage staff member has a high workload score.

If the break transfer rules are met in step 824, then step 826 updates the break transfer summary report. In certain embodiments updating the break transfer summary report updates the task list for staff B. In certain embodiments previous tasks are replaced with new or revised tasks. In other embodiments, previous tasks are updated with revisions. If break transfers rules are not met in step 824 or if the break summary report is updated in step 826, then the break management system proceeds to step 828 to determine if the break period has ended. If no, then the system loops back to step 822 to continue to monitor for tasks associated with staff member A.

If the break period has ended, then the system branches to step 830 and provides a break coverage summary report to staff member A. The break coverage summary report contains one or more patient dynamic attributes, staff dynamic attributes, and/or task dynamic attributes, e.g., tasks completed, time of completion, person who completed task and contact info, outstanding tasks, origination and received times of outstanding tasks, priority of outstanding tasks, changes in patient's condition, e.g., acuity, and notes from the break coverage person, e.g., conversation with a doctor or a patient request. In certain embodiments, the break summary report is sent to the mobile interface of staff A and updates the task list of Staff A with the outstanding tasks. In certain embodiments, tasks that Staff B still has to complete remain on the task list of staff B and reflected on the break summary report that the task is still outstanding but to be completed by Staff B.

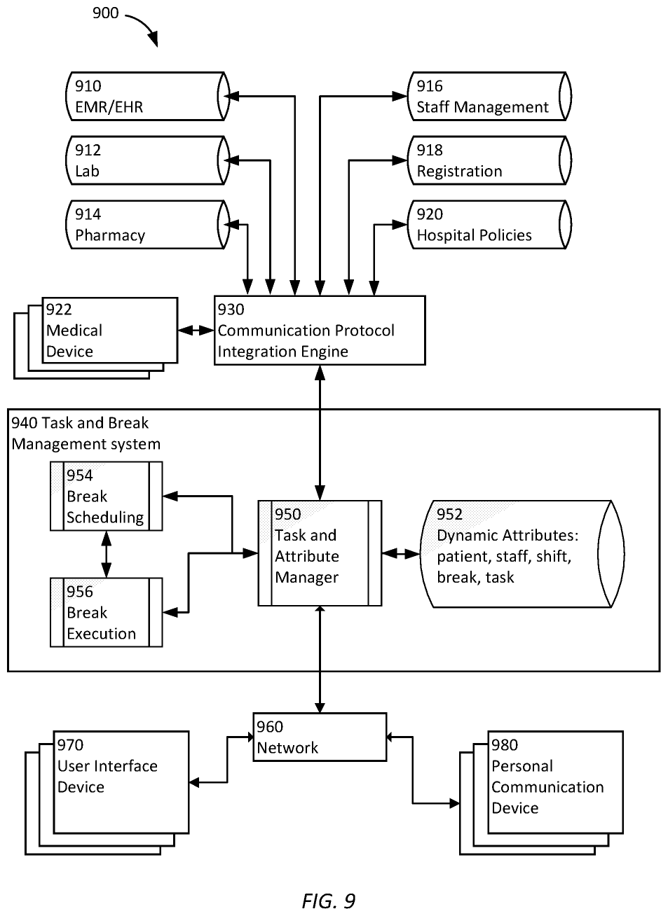

FIG. 9 depicts an exemplary system 900 for managing tasks and breaks, according to certain aspects of the present disclosure. The Task and Break Management system 940 contains data and instructions stored in a memory (not visible in FIG. 9) that, when loaded into a processor (not visible in FIG. 9) of system 940 and executed, cause the processor to implement the functions described herein. In certain embodiments, the system 940 comprises a software application that is hosted on the servers of a Software As A Service (SAAS) provider and accessible by the hospital. In certain embodiments, system 940 comprises an application hosted on a server owned and maintained by a hospital. In certain embodiments, system 940 comprises an application hosted on cloud infrastructure provided by a third party like Amazon Web Services (AWS), Google Cloud, or Microsoft Azure. In certain embodiments, system 940 comprises an application installed directly on personal computers (PCs) located in the hospital. In certain embodiments, system 940 comprises an application developed for mobile devices, e.g. smartphones or tablets, operated within the hospital. In certain embodiments, system 940 comprises a guest application that is hosted on a platform owned by a hospital or a third-party, e.g., medical device manufacturer.

In certain embodiments, system 940 is communicatively coupled to one or more third-party, hospital-based systems, e.g., an electronic health record (EHR) or electronic medical record (EMR) system 910, Lab system 912, Pharmacy system 914, Staff Management system 916, Patient Registration system 918 also referred to as an Admission, Discharge, and Transfer (ADT) system, a Hospital Policies system 920, and connected Medical Devices 922, e.g., an infusion pump or patient health monitor.

In certain embodiments, a Staff Management System 916 comprises one or more of a staff scheduling system, a patient acuity program, a leave and absence management system, a time and attendance system, a human resource information system, a credentialing system, a training and development system, and a performance management system.

In certain embodiments, a Hospital Policies system 920 comprises one or more of a policy management system, a compliance management system, a quality management system, a risk management system, a document control system, a training management system, an audit management system, an incident management system, and a fatigue management system.

In certain embodiments, system 940 communicates bidirectionally with these systems through a Communication Protocol integration engine 930 ensuring that data from the hospital-based systems is translated appropriately for system 940 and vice versa. Communication is accomplished using any defined communication protocol, e.g., Health Level 7 (HL7). In certain embodiments, one or more communication links are unidirectional.

System 900 is an exemplary representation of how system 940 is integrated into a system but other system architectures that perform the same functions are considered equivalent. In the embodiment of FIG. 9, the Task and Attribute Manager 950 receives tasks and dynamic attributes from the hospital systems and medical devices and sends this information to other modules and databases within the application. In certain embodiments, the Task and Attribute Manager 950 can create task lists, communicate attributes and task information to the Break Scheduling 954 and Break Execution 956 modules, and communicate break schedules, break execution notifications, alerts and alarm messages, and task lists through a communication protocol via a Network 960 to either a Personal Communication Device 980, e.g., a mobile phone, or a User Interface Device 970, e.g., a central nurse workstation.

The Break Scheduling module 954 creates and continuously revises break schedules using the break, shift, patient, and staff dynamic attributes that the Task and Attribute Manager 950 pulls from the Dynamic Attribute Database 952 and internal break scheduling rules. The Break Execution module 956 executes break schedules when schedules need to be executed by retrieving the break schedule and the attributes associated with the schedule from the Break Scheduling module 954 and communicating with the Task and Attribute Manager 950 to determine what task to reassign from various staff members to execute the breaks. The Break Execution module 956 has internal rules to determine how to execute breaks. In certain embodiments, system 940 allows hospital clinicians, managers, and administrators to create break scheduling, break execution, and task reassigning rules via a user interface 970.

The Dynamic Attribute Database 952 is constantly updating with new attribute information from systems 910, 912, 914, 916, 918, 922, 922. The Task and Attribute Manager 950 pulls the most recent dynamic attributes from one or more of these systems to send to the Break Scheduling module 954 to create breaks and to the Break Execution module 956 to execute breaks by determining how to reassign tasks, if necessary.

The system 940 processes inputs through User Interface Devices 970 and Personal Communication Devices 980. In certain embodiments, a staff member requests a break at a User Interface Device 970 or Personal Communication Device 980 and the Task and Attribute Manager 950 sends the request to the Break Execution module 956 to execute and to the Break Scheduling module 954 to revise the break schedule. In certain embodiments, the Task and Attribute Manager 950 sends a break request from a staff member to another User Interface Device 970 interface to get a supervisor's approval before sending to the Break Execution module 956 to execute.

### SUMMARY

The disclosed systems and method automatically analyze schedules comprising tasks and breaks and automatically provide one or more of schedules, approval of changes to breaks or schedules, and reassignment of tasks in order to enable every staff member to take all of their assigned breaks.

As used in the description of the disclosure and the appended claims, the singular forms “a,” “an” and “the” and the like are intended to include to be interpreted as equivalent to the phrase “at least one” and comprise the plural forms as well, unless the context clearly indicates otherwise. Reference to an element in the singular is not intended to mean “one and only one” unless specifically so stated.

As used in the description of the disclosure and the appended claims, pronouns in the masculine (e.g., his) include the feminine and neuter gender (e.g., her and its) equivalent and vice versa.

As used herein, “and/or” refers to and encompasses any and all possible combinations of one or more of the associated listed items as well as singular usage of each item.

As used herein, the terms “aspect” and “embodiment” are used to identify examples as to how the disclosure may be utilized and do not necessarily identify features or components that essential to the subject technology or that apply to all configurations of the subject disclosure. A disclosure relating to an aspect may apply to all configurations, or one or more configurations.

As used herein, the term “exemplary” means “serving as an example or illustration.” Any aspect or design described herein as “exemplary” is not a limiting embodiment nor to be construed as preferred or advantageous over other designs.

As used herein, the terms “include,” “contain,” “has,” “have,” and the like are intended to be inclusive in a manner similar to the term “comprise” as interpreted when employed as a transitional word in a claim.

Headings and subheadings, if any, are used for convenience only and do not limit the invention.

### Embodiments

A1. A method comprising steps of determining that a first staff member needs a break having attributes of a start time and a duration; automatically identifying a task that is assigned to the first staff member and conflicts with the break dynamic attributes; and notifying the first staff member, if no conflicting task is identified, to take the break at the start time.

A2. The method of A1, further comprising the steps of determining, if a conflicting task is identified, whether the break can be delayed long enough to complete the identified task; adjusting, if it is determined that the break can be delayed, the start time to allow completion of the identified task; and notifying the first staff member, if the start time is adjusted, to complete the identified task then take the break.

A3. The method of A2, further comprising steps of automatically selecting, if it is determined that the break cannot be delayed, a second staff member that can perform the identified task based in part on a staff dynamic attribute of the second staff member; re-assigning the identified task to the second staff member; and notifying the first staff member, if the task is re-assigned, to take the break at the start time.

A4. The method of A3, wherein the break cannot be delayed if any of the following occur: an input is received from a supervisor that the first staff member must take the break at the start time; a continuous work time of the first staff member from an end of a last break to the start time exceeds a first threshold; and a current fatigue level of the first staff member exceeds a second threshold.

A5. The method of A3, wherein the staff dynamic attribute of the second staff member comprises one or more of a group consisting of a workload; a fatigue score; and the step of selecting the second staff member comprises evaluating whether re-assigning the identified task to the second staff member will increase one of more of the workload and the fatigue score of the second staff member above a respective threshold.

A6. The method of A1, wherein the step of determining that the first staff member needs the break comprises accepting a schedule for the first staff member that comprises the break, the start time, and a duration of the break.

A7. The method of A1, wherein the step of identifying a task comprises accepting a list of one or more uncompleted tasks assigned to the first staff member; identifying a task on the list that has a task duration and a time window; automatically comparing the task duration and the time window of the identified task to the start time and the duration of the break; and determining that the identified task conflicts with the break if the identified task cannot be completed before the start time and the identified task cannot be completed within the time window if the identified task is started after the break is completed.

A8. The method of A7, wherein the identified task cannot be completed before the start time when the identified task has not been started and the identified task has a total task duration that is greater than a time difference between a current time and the start time.

A9. The method of A7, wherein the identified task cannot be completed before the start time when the identified task has been started and the identified task has a remaining task duration that is greater than a time difference between a current time and the start time.

A10. The method of A1, wherein the step of determining that the first staff member needs the break comprises receiving a request for a break at a proposed start time with a proposed duration.

All. The method of A10, wherein the request comprises changing the start time to the proposed start time.

A12. The method of A11, wherein the request comprises changing the duration to the proposed duration.

A13. The method of A12, wherein the request to change the duration comprises a request to end a current work shift at the proposed start time.

A14. The method of A10, wherein the request is received from the first staff member.

A15. The method of A1, wherein the step of determining that a first staff member needs a break is based in part on a staff dynamic attribute of the first staff member.

A16. The method of A3, further comprising the step of receiving, after the start time, a new task that is assigned to the first staff member; re-assigning the new task to the second staff member.

A17. The method of A2, further comprising the step of changing, if it is determined that the break cannot be delayed, an attribute of the break that is one or more of a group of attributes comprising the start time, the duration, and a type of break.

A18. Thew method of A1, wherein: a task conflicts with the break if the task cannot be delayed until the break is completed.

B19. A non-volatile machine-readable memory comprising instructions that, when loaded into a processor and executed, cause the processor to perform the method of A1.

C20. A system, comprising a processor and a non-volatile machine-readable memory comprising instructions that, when loaded into the processor and executed, cause the processor to perform the method of A1.

D1. A method of enabling a staff member to change a break dynamic attribute, comprising steps of requesting a modification of a schedule; determining whether the modified schedule complies with rules and constraints; and implementing, if the modified schedule complies with the rules and constraints, the modified schedule.

D2. The method of D1, further comprising determining whether a task re-assignment would resolve a conflict between the modified schedule and the rules and constraints.

D3. The method of D1, further comprising determining whether a modification of a break dynamic attribute would resolve a conflict between the modified schedule and the rules and constraints.

D3. The method of D1, wherein the modification of the schedule comprises a change in an attribute of a future break.

D4. The method of D3, wherein the break dynamic attribute comprises one or more of a break start time, a break duration, a break type, a break priority, and a location of the break.

E1. A method of re-assigning a task currently assigned to a first staff member, comprising steps of selecting a task to be re-assigned; identifying a pool candidates capable of performing the selected task based in part on one or staff dynamic attributes; determining whether re-assigning the task to a candidate selected from the pool of candidates will raise a dynamic attribute of the selected candidate above a first threshold; and re-assigning the task, if it is determined that re-assigning the task to the selected candidate will not raise the dynamic attribute above the first threshold, to the selected candidate.

E2. The method of E1, further comprising determining whether re-assigning the task to a candidate selected from the pool of candidates will raise a risk of an adverse event above a second threshold; and re-assigning the task, if it is determined that re-assigning the task to the selected candidate will not raise the risk of an adverse event above the second threshold, to the selected candidate.

F1. A method of handing off a task while a first staff member takes a break, comprising steps of identifying a task to be performed while the first staff member is on the break, the identification based in part on a task dynamic attribute of the task; creating a task transfer report comprising information about the identified task; identifying a second staff member who is capable of performing the identified task; and providing the task transfer report to the second staff member.

F2. The method of F1, wherein the step of identifying the second staff member is based in part on a dynamic attribute of the second staff member.

F3. The method of F2, wherein the dynamic attribute comprises a workload.

G1. A method of handling a task, comprising steps of detecting an initiating event, identifying a first task associated with the detected event, identifying a first staff member to whom the first task should be assigned, identifying a second task that needs to be reassigned from the first staff member to a second staff member, identifying the second staff member based in part of a dynamic attribute of the second staff member, and reassigning the second task to the second staff member.

G2. The method of G1, wherein the second task needs to be reassigned from the first staff member to the second staff member in order for the first staff member to handle the first task within a first response time window associated with the first task.

G3. The method of G2, wherein the second task second task has a second response time window that overlaps the first response time window such that the first staff member cannot complete the second task if the first staff member starts the second task after the first response time window ends.

H1. A method of reducing a fatigue level of a staff member, comprising steps of determining that the fatigue level of a first staff member exceeds a first threshold; identifying an option for reducing the fatigue level of the first staff member, wherein the option comprises reassigning a task from the first staff member; selecting the task to be re-assigned; identifying a second staff member based in part on a first dynamic attribute of the second staff member; and reassigning the task from the first staff member to the second staff member.

H2. The method of H1, wherein the fatigue level is based in part on a second dynamic attribute of the first staff member.

H3. The method of H2, wherein the fatigue level is based in part on a workload.

All structural and functional equivalents to the elements of the various aspects described throughout this disclosure are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

This application includes description that is provided to enable a person of ordinary skill in the art to practice the various aspects described herein. While the foregoing has described what are considered to be the best mode and/or other examples, it is understood that various modifications to these aspects will be readily apparent to those skilled in the art, and the generic principles defined herein may be applied to other aspects. Although embodiments of the present disclosure have been described and illustrated in detail, it is to be clearly understood that the same is by way of illustration and example only and is not to be taken by way of limitation, the scope of the present invention being limited only by the terms of the appended claims.

We claim:

1. A method, comprising steps:
determining that a first staff member needs a break, the break having attributes of a start time and a duration;
automatically identifying a task that is assigned to the first staff member and conflicts with the break; and
notifying the first staff member, if no conflicting task is identified, to take the break at the start time.

2. The method of claim 1, further comprising the steps:
determining, if a conflicting task is identified, whether the break can be delayed long enough to complete the identified task;
adjusting, if it is determined that the break can be delayed, the start time to allow completion of the identified task; and
notifying the first staff member, if the start time is adjusted, to complete the identified task then take the break.

3. The method of claim 2, further comprising steps:
automatically selecting, if it is determined that the break cannot be delayed, a second staff member that can perform the identified task based in part on a staff dynamic attribute of the second staff member;
re-assigning the identified task to the second staff member; and
notifying the first staff member, if the task is re-assigned, to take the break at the start time.

4. The method of claim 3, wherein the break cannot be delayed if any of the following occur:
an input is received from a supervisor that the first staff member must take the break at the start time;
a continuous work time of the first staff member from an end of a last break to the start time exceeds a first threshold; and
a current fatigue level of the first staff member exceeds a second threshold.

5. The method of claim 3, wherein:
the staff dynamic attribute of the second staff member comprises one or more of a group consisting of:
a workload; and
a fatigue score; and
the step of selecting the second staff member comprises evaluating whether re-assigning the identified task to the second staff member will increase one of more of the workload and the fatigue score of the second staff member above a respective threshold.

6. The method of claim 1, wherein the step of determining that the first staff member needs the break comprises accepting a schedule for the first staff member that comprises the break, the start time, and a duration of the break.

7. The method of claim 1, wherein the step of identifying a task comprises:
accepting a list of one or more uncompleted tasks assigned to the first staff member;
identifying a task on the list that has a task duration and a time window;
automatically comparing the task duration and the time window of the identified task to the start time and the duration of the break; and
determining that the identified task conflicts with the break if the identified task cannot be completed before the start time and the identified task cannot be completed within the time window if the identified task is started after the break is completed.

8. The method of claim 7, wherein the identified task cannot be completed before the start time when the identified task has not been started and the identified task has a total task duration that is greater than a time difference between a current time and the start time.

9. The method of claim 7, wherein the identified task cannot be completed before the start time when the identified task has been started and the identified task has a remaining task duration that is greater than a time difference between a current time and the start time.

10. The method of claim 1, wherein the step of determining that the first staff member needs the break comprises receiving a request for a break at a proposed start time with a proposed duration.

11. The method of claim 10, wherein the request comprises changing the start time to the proposed start time.

12. The method of claim 11, wherein the request comprises changing the duration to the proposed duration.

13. The method of claim 12, wherein the request to change the duration comprises a request to end a current work shift at the proposed start time.

14. The method of claim 10, wherein the request is received from the first staff member.

15. The method of claim 1, wherein the step of determining that a first staff member needs a break is based in part on a staff dynamic attribute of the first staff member.

16. The method of claim 3, further comprising the step:
receiving, after the start time, a new task that is assigned to the first staff member;
re-assigning the new task to the second staff member.

17. The method of claim 2, further comprising the step of:
changing, if it is determined that the break cannot be delayed, an attribute of the break that is one or more of a group of attributes comprising the start time, the duration, and a type of break.

18. Thew method of claim 1, wherein: a task conflicts with the break if the task cannot be delayed until the break is completed.

19. A non-volatile machine-readable memory comprising instructions that, when loaded into a processor and executed, cause the processor to perform the method of claim 1.

20. A system, comprising:
a processor; and
a non-volatile machine-readable memory comprising instructions that, when loaded into the processor and executed, cause the processor to perform the method of claim 1.
